(19) United States
(12) Patent Application Publication
(10) Pub. No.: US 2012/0013226 A1
(43) Pub. Date: Jan. 19, 2012

(54) INTERFERENCE SUPPRESSION ARRANGEMENT FOR AN ELECTRIC MACHINE

(75) Inventors: Armin Stubner, Buehl-Altschweier (DE); Richard Hurst, Offenburg (DE); Norbert Martin, Achern (DE)

(73) Assignee: ROBERT BOSCH GMBH, Stuttgart (DE)

(21) Appl. No.: 13/142,948

(22) PCT Filed: Nov. 5, 2009
(86) PCT No.: PCT/EP2009/064658

§ 371 Date: Oct. 5, 2011

(30) Foreign Application Priority Data
Jan. 5, 2009 (DE) 10 2009 000 024.0

(51) Int. Cl. H02K 11/02

(52) U.S. Cl. 310/68 R

(57) ABSTRACT

An anti-interference system (86) for an electric machine (10) comprises a single-piece or multi-piece housing component (56) and a single-piece or multi-piece shielding component (30). The housing component (56) together with the shielding component (30) forms a faraday cage (84). The faraday cage (84) encloses at least one first interference suppression choke (44). An electric machine, particularly a wiper motor, comprises an anti-interference system (86) as described above.

### BACKGROUND OF THE INVENTION

The invention relates to an interference suppression arrangement for an electric machine. The interference suppression arrangement comprises a single-piece or multi-piece housing component and a single-piece or multi-piece shielding component, the housing component together with the shielding component forming a Faraday cage. In addition, the invention relates to an electric machine, in particular a wiper motor.

DD 12956 describes a conventional interference suppression element. In this case, a threaded connection piece is fixed in the wall of a metallic shielding housing of a windshield wiper motor, said threaded connection piece providing a tubular joint between the interior of the shielding housing and its surrounding environment. A leadthrough capacitor is inserted into the tubular joint, said leadthrough capacitor completely filling the tubular joint. A positive feed line for the windshield wiper motor is guided through the leadthrough capacitor. The conventional interference suppression element no longer meets the increased requirements placed on electromagnetic compatibility with modern radio services and vehicle systems.

### SUMMARY OF THE INVENTION

An object of the present invention is to provide an interference suppression arrangement of the generic type which takes account of the increased requirements placed on electromagnetic compatibility with modern radio services and vehicle systems. Furthermore, an object of the invention is to provide an electric machine, in particular a wiper motor, with this advantage.

The invention builds upon the interference suppression arrangement of the generic type in such a way that the Faraday cage surrounds at least one first interference suppression inductor.

A preferred embodiment envisages that the Faraday cage completely surrounds a brushgear of the electric machine.

In an advantageous embodiment, the Faraday cage surrounds a grounding line of the electric machine, the Faraday cage being electrically connected to the grounding line.

An embodiment which is also preferred envisages that the first interference suppression inductor or a further interference suppression inductor is introduced in the grounding line.

A further development envisages that at least one leadthrough capacitor is arranged in a wall of the Faraday cage.

Preferably, the interference suppression arrangement can be characterized by the fact that the leadthrough capacitor comprises a ceramic tube, which is metal-plated on a tube inner side and/or on a tube outer side.

It is advantageous if the housing component and/or the shielding component has a receptacle for pressing in the leadthrough capacitor, in particular in an axial and/or in a radial direction.

It is also particularly preferred if the Faraday cage surrounds a first interference suppression capacitance.

In addition, the invention builds upon an electric machine of the generic type by virtue of the fact that the electric machine, in particular the wiper motor, comprises an interference suppression arrangement according to the invention.

### BRIEF DESCRIPTION OF THE DRAWINGS

The invention will now be explained with reference to the attached figures using particularly preferred embodiments.

In the figures:

FIG. 1 shows a schematic basic circuit diagram for explaining electrical wiring of the interference suppression components according to the invention;

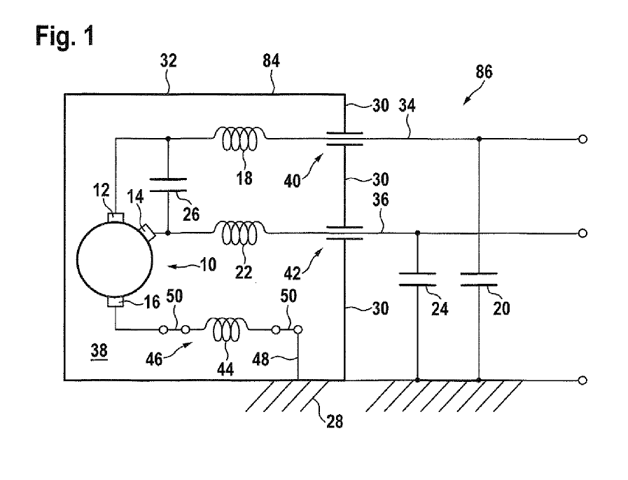

FIG. 2 shows a perspective, schematic sketch of a physical arrangement, according to the invention, of interference suppression components in the region of the shielding plate; and

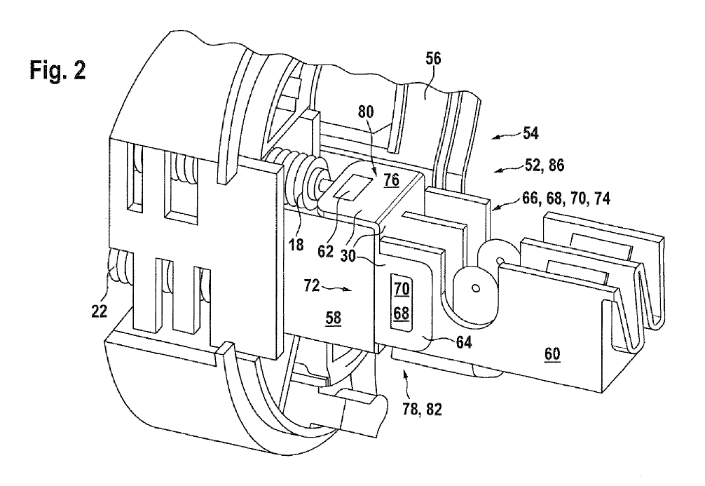

FIG. 3 shows a perspective sketch of a leadthrough capacitor and a physical arrangement, according to the invention, of the leadthrough capacitor in the tail element.

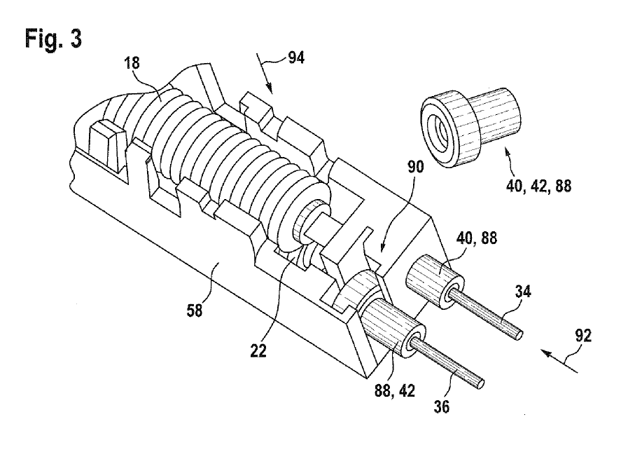

### DETAILED DESCRIPTION

Low-power motors 10 are generally provided with simple L/C interference suppression in order to suppress electrical interference which is caused by brush sparking. In a standard wiper motor 10, the two wiper speeds required by law are generally implemented by means of two positive brushes 12, 14. Typically, a first of the two positive brushes 12, 14 is diametrically opposite a ground brush 16, while the other of the two is arranged at an acute circumferential angle of 70°, for example, with respect to the first positive brush 12. As a result, the other of the two brushes 12, 14 is not arranged diametrically opposite the ground brush 16. In this case, both brushes 12, 14 are subjected to interference suppression with in each case one dedicated L/C circuit 18, 20 and 22, 24, respectively. In the process, the connection of the respective brush to a respective electrical feed line 34 or 36 takes place via the inductance 18 or 22, with the connection of the inductance 18 or 22 on the power supply side being short-circuited in terms of radiofrequency with respect to ground 28 by means of a capacitance 20 or 24. This is then referred to as 2L/2C interference suppression. In order to improve the interference suppression in the long-wave range, a third capacitance 26 can be used, which is connected between the terminals of the two positive brushes 12, 14. 2L/2C and 2L/3C interference suppression systems effectively suppress average levels of interference, but are relatively ineffective with respect to temporarily occurring interference events which are manifested in so-called “interference peaks”. The “interference peaks” tend to be unproblematic for earlier analog radio and telecommunication services, but result in failures in the case of digital communication systems, such as Bluetooth and digital radio services (digital broadcast).

According to the invention, a shielding component 30, which is connected to ground 28, is arranged in such a way that the brushgear 12, 14, 16 (and therefore the original source of the radio interference) is encapsulated completely in the pole housing 32. Preferably, the shielding component 30 is an electrically conductive shielding plate. The electrical feed lines 34, 36 are passed through the shielding plate 30. In order to prevent interference signals from being passed out of the brush area 38, the two positive lines 34, 36 of the two-stage motor 10 are short-circuited in terms of radiofrequency by the shielding plate 30 by means of in each case one leadthrough capacitor 40 or 42. A further improvement is possible by means of inserting an inductor 44 into the grounding path 46 of the wiper motor 10. A thermostatic switch 50 can be inserted into the grounding line 48 at any desired point, i.e. between the ground brush 16 and the third inductor 44 or between the third inductor 44 and the brush housing 32, for example.

A module 52 for accommodating the interference suppression inductors 18, 22 is arranged in the motor housing 54 as follows. The module 52 passes from a pole housing 56 through a motor flange (not illustrated) into a transmission box (not illustrated). The module 52 comprises a tail element 58 with interference suppression inductors 18, 22, a front element 60 with contact springs to form a transmission cover (not illustrated), and a shielding plate 30 between the tail element 58 and the front element 60. In addition to the shielding function, the shielding plate 30 can also have the function of fixing the front element 60 mechanically to the tail element 58. For this purpose, the shielding plate 30 can have two lug-like protrusions 64, 66, in the direction towards the front element 60, each having a cutout 68, said protrusions being provided for the purpose of surrounding the front element 60 on two sides 72, 74 in the manner of clamps. The front element 60 has two tabs 70, which are provided for engaging, in the manner of hooks, in the cutouts 68 in the lug-like protrusions 64, 66. An identical mechanical connection can also be provided between the shielding plate 30 and the tail element 58. It is expedient here to arrange the two lugs 64, 66 for the front element 60 on a left-hand side 72 and right-hand side 74 of the shielding plate 30 when the two lugs 76, 78 for the tail element 58 are arranged on the upper side 80 and lower side 82 of the shielding plate 30. Alternatively, it may also be expedient to arrange the two lugs 76, 78 for the tail element 58 on a left-hand side 72 and right-hand side 74 of the shielding plate 30 and the two lugs 64, 66 for the front element 60 on the upper side 80 and lower side 82 of the shielding plate 30. The pole housing 56, the transmission flange housing and the shielding plate 30 form a closed Faraday cage 84. The shielding plate 30 provides a shielding in the passage from the pole housing 56 to the transmission box. It is expedient to preliminary solder the two leadthrough capacitors 40, 42 onto connecting wires 34, 36 of the inductors 18, 22 and to insert them together with the respective inductor 18, 22 into the tail element 58.

The interference suppression arrangement 86 for the electric machine 10 comprises a single-piece or multi-piece housing component 56 and a single-piece or multi-piece shielding component 30. The housing component 56 forms, together with the shielding component 30, a Faraday cage 84. The Faraday cage 84 surrounds at least a first interference suppression inductor 18. In addition, the Faraday cage 84 surrounds a brushgear 12, 14, 16 and a grounding line 48 of the electric machine 10 completely. The Faraday cage 84 is electrically connected to the grounding line 48. At least one leadthrough capacitor 40, 42 is arranged in a wall 30 of the Faraday cage 84. Each of the leadthrough capacitors 40, 42 can surround a metal-plated ceramic tube 88 on a tube inner side and/or on a tube outer side. The housing component 56 and/or the shielding component 30 can surround a receptacle 90 for pressing in the leadthrough capacitor 40, 42, in particular in an axial direction 92 and/or in a radial direction 94 of the tail part 58. The Faraday cage 84 can also envelop a first interference suppression capacitance 26. In principle, the invention can be applied to any type of electrical machines with brushes 12, 14, 16 and is particularly advantageous for wiper motors 10. A further interference suppression inductor 44 can be inserted in the grounding line 48.

1. An interference suppression arrangement (86) for an electric machine (10), comprising a housing component (56) and a shielding component (30), the housing component (56) together with the shielding component (30) forming a Faraday cage (84), characterized in that the Faraday cage (84) surrounds at least one first interference suppression inductor (18).

2. The interference suppression arrangement (86) as claimed in claim 1, characterized in that the Faraday cage (84) completely surrounds a brushgear (12, 14, 16) of the electric machine (10).

3. The interference suppression arrangement (86) as claimed in claim 1, characterized in that the Faraday cage (84) surrounds a grounding line (48) of the electric machine (10), the Faraday cage (84) being electrically connected to the grounding line (48).

4. The interference suppression arrangement (86) as claimed in claim 3, characterized in that the first interference suppression inductor (18) is introduced in the grounding line (48).

5. The interference suppression arrangement (86) as claimed in claim 1, characterized in that at least one leadthrough capacitor (40) is arranged in a wall (30) of the Faraday cage (84).

6. The interference suppression arrangement (86) as claimed in claim 5, characterized in that the leadthrough capacitor (40) comprises a ceramic tube (88).

7. The interference suppression arrangement (86) as claimed in claim 5, characterized in that the housing component (56) has a receptacle (90) for pressing in the leadthrough capacitor (40).

8. The interference suppression arrangement (86) as claimed in claim 1, characterized in that the Faraday cage (84) surrounds a first interference suppression capacitance (26).

9. A wiper motor electric machine, characterized in that the electric machine comprises an interference suppression arrangement (86) as claimed in claim 1.

10. The interference suppression arrangement (86) as claimed in claim 1, characterized in that the housing component (56) is one of a single-piece housing component (56) and a multi-piece housing component (56).

11. The interference suppression arrangement (86) as claimed in claim 1, characterized in that the shielding component (30) is one of a single-piece shielding component (30) and a multi-piece shielding component (30).

12. The interference suppression arrangement (86) as claimed in claim 3, characterized in that a further interference suppression inductor (44) is introduced in the grounding line (48).

13. The interference suppression arrangement (86) as claimed in claim 6, characterized in that the ceramic tube (88) is metal-plated on a tube inner side and on a tube outer side.

14. The interference suppression arrangement (86) as claimed in claim 6, characterized in that the ceramic tube (88) is metal-plated on a tube inner side or on a tube outer side.

15. The interference suppression arrangement (86) as claimed in claim 5, characterized in that the shielding component (30) has a receptacle (90) for pressing in the leadthrough capacitor (40).

16. The interference suppression arrangement (86) as claimed in claim 15, characterized in that the leadthrough capacitor (40) is pressed into the receptacle (90) in an axial (92) and in a radial (94) direction.

17. The interference suppression arrangement (86) as claimed in claim 15, characterized in that the leadthrough capacitor (40) is pressed into the receptacle (90) in an axial (92) or in a radial (94) direction.

18. The interference suppression arrangement (86) as claimed in claim 7, characterized in that the leadthrough capacitor (40) is pressed into the receptacle (90) in an axial (92) or in a radial (94) direction.

19. The interference suppression arrangement (86) as claimed in claim 7, characterized in that the leadthrough capacitor (40) is pressed into the receptacle (90) in an axial (92) and in a radial (94) direction.
